(19) United States
(12) Patent Application Publication
(10) Pub. No.: US 2017/0132632 A1
(43) Pub. Date: May 11, 2017

(54) METHOD AND SYSTEM FOR AUTHENTICATING A USER OF A MOBILE DEVICE FOR THE PROVISION OF MOBILE COMMUNICATION SERVICES

(71) Applicant: GLOBETOUCH AB, Stockholm (SE)

(72) Inventor: Björn KNUDSEN, Hasselby (SE)

(21) Appl. No.: 15/317,234

(22) PCT Filed: Jun. 8, 2015
(86) PCT No.: PCT/SE2015/050661

§ 371 Date: Dec. 8, 2016

(30) Foreign Application Priority Data
Jun. 10, 2014 (SE) 1450708-1

(51) Int. Cl. G06Q 20/40; H04L 29/06; G06Q 20/32; H04W 12/06

(52) U.S. Cl. CPC G06Q 20/4014; H04W 12/06; H04L 63/0861; H04L 63/083; G06Q 20/3229

(57) ABSTRACT

A method, a system and a piece of software for authenticating a user (110) of a mobile communication device (120) for the provision of mobile communication services for the mobile device, which mobile device includes a digital camera (121). The method including the steps of:
a) providing a SIM (Subscriber Identity Module) card to the user;
b) providing via the mobile communication device an interface via which the user can register or purchase a mobile communication service provided using the SIM card;
c) allowing the user to take a digital photograph showing a piece of identification (111) using the digital camera;
d) communicating the photograph from the mobile device to a central server (150), which central server keeps user account data relating to the user and/or SIM card; and
e) providing to mobile communication device access to the mobile communication service.

The present invention relates to a method and a system for authenticating a user of a mobile device for the provision of mobile communication services. In particular, the invention relates to such purchases performed using the same mobile device by the use of which such mobile communication services will be performed after the purchase. Especially, the invention relates to the purchasing and provisioning of a new mobile communication services subscription.

Today, users of mobile communication devices, such as mobile telephones, can purchase mobile communication services, such as data connectivity over GPRS, 3G or 4G, in various ways. This is in particular true for the initial setting up of a new subscription.

In some countries, it is for regulatory reasons required for the purchasing user to provide identification documents to the seller of the subscription, in order to prove the identity of the user. Manual identification verification can be performed by personnel in a physical store selling subscriptions. In case a subscription is purchased from a remote location, such as online, a SIM (Subscriber Identity Module) card required for the use of the subscription can be delivered using a postal service such that the user must present a valid piece of identification in order to collect the parcel containing the SIM card.

The Swedish patent application SE1251503-7, which has not been published at the filing date of the present application, describes a method for online registering of a user to a mobile communication service, in which a corresponding SIM card may be distributed beforehand to the user and then activated when needed by simply switching on internet connectivity of the mobile communications device, visiting a predetermined internet page providing registering functionality, entering user credentials and then being provided general internet connectivity according to the terms of the subscription purchased. Before the registration, the SIM card cannot be used for mobile communication services.

This solution is convenient for the user, but still may require that proper user identification is performed manually, by showing a valid piece of identification documentation, in some countries before distributing the SIM card to the user.

The present invention solves these problems.

Thus, the invention relates to a method for authenticating a user of a mobile communication device for the provision of mobile communication services for the mobile device, which mobile device comprises a digital camera, which method is characterized in that the method comprises the steps of a) providing a SIM (Subscriber Identity Module) card to the user; b) providing via the mobile communication device an interface via which the user can register or purchase a mobile communication service provided using the SIM card; c) allowing the user to take a digital photograph showing a piece of identification using said digital camera; d) communicating the photograph from the mobile device to a central server, which central server keeps user account data relating to the user and/or SIM card; and e) providing to mobile communication device access to the mobile communication service.

Further, the present invention relates to a system for authenticating a user of a mobile communication device for the provision of mobile communication services for the mobile device, which mobile device comprises a digital camera, which system is characterized in that it comprises a central server arranged to receive, from the mobile device), firstly information identifying the user and/or a SIM card installed in the mobile device and, secondly, an image depicting a piece of identification of the user, and in that the central server is arranged to, upon such receipt, cause the mobile communication device to be provided access to the mobile communication service.

Moreover, the present invention relates to a piece of computer software code runnable on or from a mobile communication device comprising a digital camera, which software code is arranged to be used for authenticating a user of the mobile communication device for the provision of mobile communication services for the mobile device, which software code is arranged to provide, via the mobile communication device, an interface via which the user can register or purchase a mobile communication service provided using a SIM card installed in the mobile communication device, which software code is characterized in that the interface is arranged to, as a part of a registration step of the SIM card, connect the mobile communication device to a central server keeping user account data relating to the user and/or SIM card, to allow the user to take a digital photograph showing a piece of identification using said digital camera, and to communicate the photograph from the mobile device to the central server.

In the following, the invention will be described in detail, with reference to the appended drawings, where:

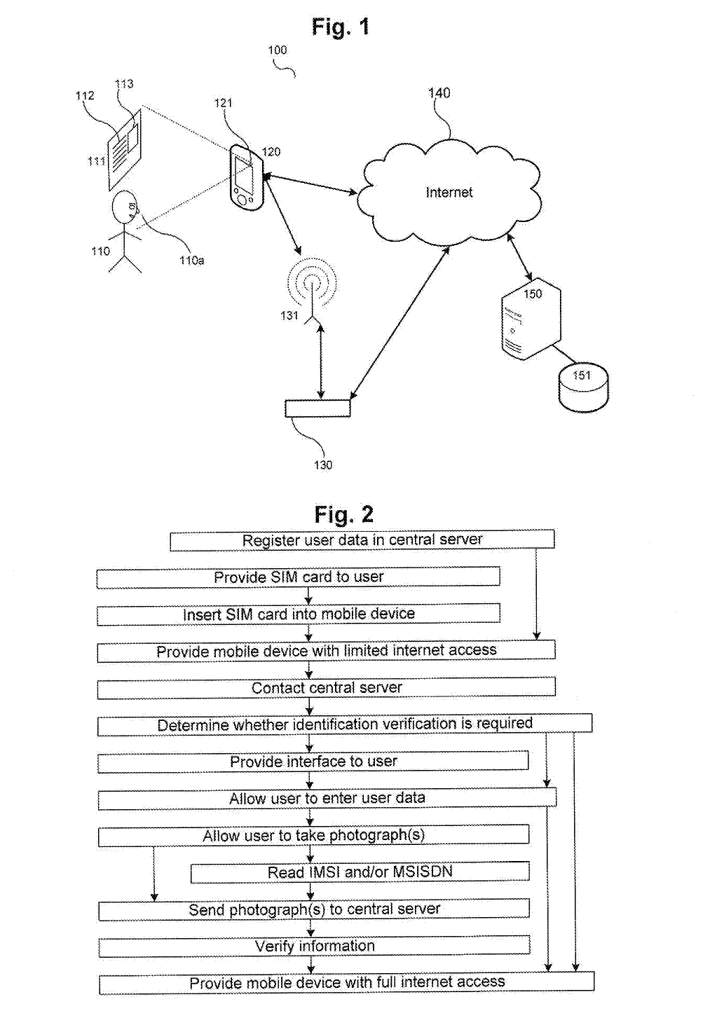

FIG. 1 is a simplified overview diagram of a system according to the present invention for use in a method according to the present invention;

FIG. 2 is a flow chart of a method according to the present invention;

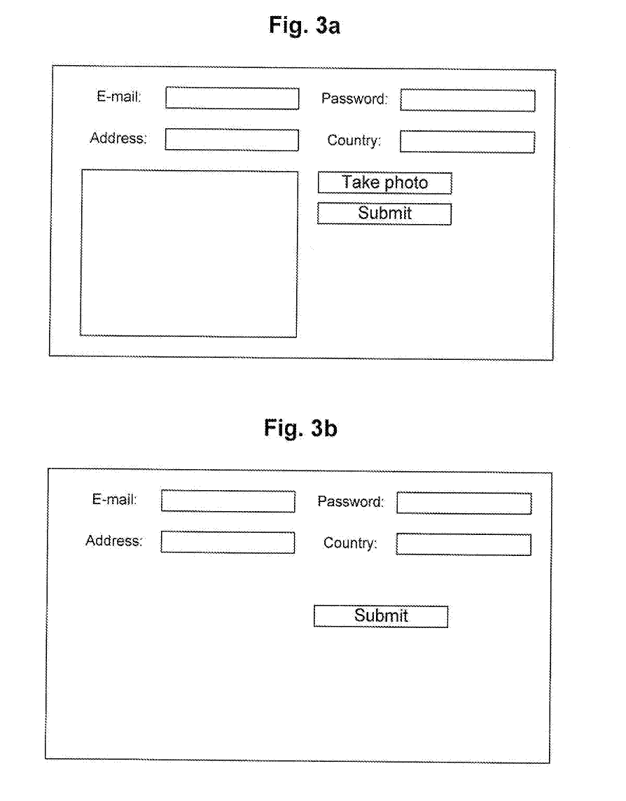

FIG. 3a shows an interactive graphical user interface when a user identification verification is required; and

FIG. 3b shows an interactive graphical user interface when a user identification verification is not required.

Hence, FIG. 1 illustrates a system 100 according to the present invention, arranged to perform a method according to the invention. The system 100 comprises, at least, a central server 150 with a connected or integrated database 151. The central server 150 may be standalone or distributed, and is connected to the internet 140.

A mobile communications network 130 comprises an antenna 131 for wireless communication with a portable communications device 120, such as a mobile telephone, preferably of a so-called “smartphone” typ, which comprises programmable general-purpose computer hardware functionality. The device 120 comprises a digital camera 121, in other words an optical image-capturing device capable of storing captured images in digital format. As such, a scanner may for instance also be used. It is for security reasons preferred that the camera 121 is integrated in the mobile device 120, in the sense that it can be directly controlled using a main central processing unit (CPU) of the device 120, and even more preferably not possible to control without actively involving control hardware arranged as an integrated part of the mobile device 120. Hence, it is for instance preferred that the camera 121 is not in the form of a cable-connected or peripheral device to the device 120.

The device 120 comprises a SIM card using which the device 120 is identified to the network 130 and communication services are provided to the device 120 by the network 130.

The wireless network 130 may be of any suitable type which is capable of wirelessly transmitting digital information between the device 120 and the internet 140, such as a GPRS, 3G or LTE network. The network 130 is also connected to the internet 140, so that connected devices 120 can be provided with internet 140 access via network 130. The internet connection may be any suitable type, such as for instance via a second network (not shown) collaborating with the network 130 in the provision of internet access to the device 120, such as via a GRX (GPRS Roaming Exchange) (not shown). The mobile device 120 may also be connected directly to the internet 140 without using the network 130, such as via WiFi.

The central server 150 and the database 151 can also, in some embodiments, be a part of the network 130 infrastructure, in which case the network 130 and central server 150 may communicate directly, without using the internet 140.

110 denotes a user of the device 120. 111 denotes a piece of identification, such as a passport or a driver's license, belonging to the user 110 and serving to prove the identity of the user 110 as a holder of the identification 111. The identification 111 may comprise printed alphanumeric information 112, in turn comprising printed alphanumeric character, and also a printed photograph 113 of the user's 110 face 110a.

FIG. 2 illustrates the different method steps of a method according to the present invention for authenticating the user 110 of the device 120 for the provision of a certain mobile communication service to the mobile device 120, which mobile device 120 comprises a digital camera 121. It is realized that the method steps in FIG. 2 can be performed in slightly different order, as will be detailed in the following.

In a first step, the user 110 is registered in the central server 150, preferably by a user account being created in the database 151 for the user and/or the said SIM card. This step can be performed at any time prior to the SIM being used for communication services in subsequent steps, but according to a preferred embodiment it is performed in connection to or after the purchasing of a SIM (Subscriber Identity Module) card for use with a method according to the invention. Such purchase is preferably made from a point of sale which is not attended by sales staff. For instance, it may be an automated point of sale, at which a SIM card is delivered physically to the user 110 upon valid payment using for instance a credit card. The SIM card may, for instance, be preloaded with a certain amount of data communication traffic when purchased. In this embodiment, user data, such as credentials in the form of a user name and a password for signing into an online user account, is either exchanged between the user 110 and the central server 150, via the physical point of sale and using a suitable interface in connection to the point of sale, or the user is required to create such an account and supply user data, for instance via a suitable home page provided by the central server 150, before the SIM card can be used.

According to another embodiment, the SIM card is purchased online, in which case the user data may be provided in connection to the purchasing of the SIM card.

The user data may also be provided, and the user 110 hence registered in the central server 150, in connection to the below described verification steps and using the interactive user interface described below.

The said user data comprises data using which the user can be uniquely identified. Hence, the user data may be a social security number, a passport number, a full name and residence address, or the like.

In a second step, the said SIM card is provided to the user, in a way which depends on the point of sale. At a physical point of sale, the distribution may be using a vending machine or the like. For an online purchase, on the other hand, the present invention provides for the possibility to distribute the SIM card in a manner which only provides for low security, such as using ordinary land mail. Since the SIM card may not be used for anything before the user has been authorized anyway (see below), the unauthorized SIM card cannot be used to do any harm.

In a third step, the SIM card is inserted into the mobile device 120. This step may also be completed beforehand, such as distributing a mobile device 120 with a built-in SIM card of the present type.

According to a preferred embodiment, in a fourth step, which is performed before the fifth step (below), the mobile device 120 is provided a limited internet access, via the antenna 131 and by the network 130, as opposed to general internet access. Specifically, the limited access is preferably internet access to a specific internet address, which preferably is associated with the server 150. In other words, the mobile device 120 can in this example only be used to access the server 150, and no other parts of the internet 140. In particular, the mobile device 120 can contact the central server 150 via the said specific internet address, such as using a internet address which has previously been stored in the mobile device 120 or by automatic redirection to the central server 150.

In case no limited internet access is provided, the mobile device can simply contact the central server 150, for instance using said previously stored address.

In this and other method steps according to the present invention, the actions performed by the mobile device 120, such as contacting the central server 150 or providing the user with the below discussed interactive graphical user interface, such method steps are preferably performed by a piece of computer software which is executable and executed on or from the mobile device 120, such as a locally installed software application running on the device 120; a web service accessed from the mobile device 120; or software functionality provided in connection to an HTML5 web page, accessed by the mobile device 120.

The communications between the mobile device 120 and the central server 150 described herein may be performed by, for instance, the user using a web browser application in the mobile device 120 for browsing to a web page provided by a web server comprised in the central server 120, at which web page the user can perform various method steps by interacting with user controls. However, according to a preferred embodiment communications between the mobile device 120 and the central server 150 may also be performed via a digital communication interface provided by the central server 150 specifically for accepting communications from mobile devices 120 of the type shown in FIG. 1. This way, much of the method according to the present invention can be automated and offer the user a small footprint user experience. For instance, it is preferred that the said computer software is arranged to automatically detect the insertion of the SIM card in the third step, and to automatically perform the contacting of the server 150 upon such insertion, thereby initiating a registration procedure.

Hence, according to a preferred embodiment, in a fifth step, the mobile device 120 contacts the central server 150, preferably using said interface provided by the server 150 and preferably also using said computer software at the device 120. The contacting in this fifth step may be via network 130, using the device's 120 SIM card, or directly over the internet 140, via WiFi or the like.

Upon this contacting, the central server 150 is arranged to determine, in a sixth step, whether or not the user 110 is obliged to provide a valid piece of identification before the SIM card can be activated. This determining is preferably performed based upon which country or mobile communications network from which the mobile device 120 connects to the central server 150. This information may in turn be acquired from metadata associated with the connection, such as the IP address of the contacting mobile device 120 if connecting over WiFi. The information may also be based upon an IMSI (International Mobile Subscriber Identity) code or an MSISDN code provided by the mobile device 120 (such as in a step similar to the ninth step, see below). It is preferred that the connection in the fifth step is performed via network 130, in which case the IMSI of the SIM card is used to determine the identity of the SIM card, and therefore whether identification verification is necessary or not, or that the connection is performed using WiFi or any other direct internet connection, in which case the mobile device is arranged to read the IMSI of the SIM card and send it to the central server 150.

The database 151 preferably contains information associating each country and/or network and/or SIM card in or using which a method according to the present invention can be performed with respective requirements regarding the local minimum identification requirements in that particular country and/or network, or using that particular SIM card. It is also possible for the SIM card itself, preferably identified by its IMSI code, to be associated, in the database 151, with at least a requirement that the user registers a user account and logs in to such account before the SIM card can be used for communication services.

In case no further identification is required, the method may immediately skip to the last method step in FIG. 2, or it may proceed to the seventh and subsequent steps, allowing the user to enter user data, or additional user data, but without requiring the verification described in the twelfth step (below).

Hence, according to the present invention the mobile device 120 is arranged to, in a seventh step, provide to the user 110 an interactive, preferably graphical, user interface, via which and via the mobile device 120 the user 110 can register, enter (additional) user data and/or purchase a mobile communication service provided using the SIM card. According to a preferred embodiment, in which the determining in the above described sixth step results in that further authentication is necessary, the user 110 needs not do any of the registration as described above before the performance of this seventh step.

FIG. 3a illustrates a simple example of such an interactive user interface, comprising fields where the user 110 can enter an identifying e-mail address and an association password, as well as an address and a country of residence. Furthermore, a viewing frame (below the “Address” field) is arranged to show the viewfinder of the camera 121, and there are buttons for taking a photo and submitting the information and the photo.

FIG. 3b illustrates a corresponding interface, but in case the determining sixth step resulted in there being no requirement for identification verification.

Hence, according to a preferred embodiment, regardless of whether the user 110 must verify the identification 111 or not, the interface provided to the user 110 in the seventh step can be used, in an eighth step, to enter user data, preferably comprising credential data for a user account kept on the central server 150. This may comprise registering the user 110 for the first time with the system 100, or registering the particular SIM card being inserted in the above third step to the user 110. It is, in such case, preferred that the SIM card, as identified by the corresponding IMSI or MSISDN code, is not associated with the user account before the entering of the user information in this eighth step. This provides for a particularly simple, flexible and yet secure solution. However, if the user 110 already has registered such user data, the interactive interface may only provide a login screen.

According to one preferred embodiment, however, the user is not required to manually enter any credential information in the eighth step. Instead, the SIM card has already been assigned to the user 110, for example by the identification 111 having been photographed at a physical point of sale in convection to the purchasing of the SIM card, or by ordering the SIM card using a web site into which the user was already logged in before ordering the SIM card, such as the home page user portal of the network 130 operator or the central server 150. Then, the SIM card as such, such as via its IMSI code, is associated with the user account in the database 151, so that the user 110 is automatically identified by the central server 150 once the mobile device 120 connects to the central server 150 in the fifth and/or eleventh step (below), which connections will then comprise the mobile device 120 reading and communicating said IMSI to the central server 150.

Further according to the invention, in a ninth step, the user 110 is allowed, preferably by the said interactive user interface provided by said software run on or from the device 120, to take a digital photograph showing a piece of identification using the said digital camera 121 of the mobile device 120. This may be performed by the said software activating the integrated camera 121 and allowing the user to press the button “Take photo” as shown in FIG. 3a, which will cause the software function to capture, using the camera 121, an image of the user 110 and/or the piece of identification 111, which image at the moment is in the camera's viewfinder.

Then, in an eleventh step, the mobile device 120, preferably by the said software function, is arranged to communicate the captured photograph from the mobile device 120 to the central server 150. For instance, this may take place by the user pressing the “Submit” button of FIG. 3a. This communication should be in relation to the specific user 110 and/or the specific SIM card in any of the ways described above, such as using a previously established logged in user session or by reading the IMSI from the SIM card. It is noted that the central server 150 at the latest in connection to this communication will keep user account data relating to the user 110 and/or to the SIM card.

In a preferred embodiment, in which the SIM card is inserted into the mobile device 120 before the eleventh step, the mobile device 120 reads an IMSI code and/or MSISDN code from the SIM card. Then, the eleventh step comprises that the mobile device 120, preferably via said software function, communicates to the central server 150 the read IMSI code and/or MSISDN code.

Then, in a twelfth information verification step performed upon the receipt of the above discussed image and possibly also user data and/or IMSI code and/or MSISDN code, the central server 150 is arranged to verify the received information, and to, in a thirteenth step, provide to the mobile device 120 access to the above mentioned mobile communication service.

According to a preferred embodiment, which is particularly relevant in case a limited internet access was granted to the mobile device 120 in the fourth step, above, the mobile device 120 is now provided general internet access. How this can be done, in particular in case the network 130 acts as a local roaming collaborating partner with a different network, being a home network to the device 120, is described in closer detail in the above referenced Swedish patent application SE1251503-7. In particular, general internet connectivity can be provided by the central server 150 instructing the network 130 provision the mobile device 120, via its SIM card, with such general internet access.

It is preferred that the said mobile communication service comprises mobile internet connectivity. Preferably, the SIM card is preconfigured to only be used for providing mobile data communications, as opposed to pure voice communication.

The provisioning of said services to the mobile device 120 can, for instance, take place by the central server 150 communicating with the network 130, which in turn provisions the services to the mobile device 120 using the SIM card in question.

In case the said IMSI code and/or MSISDN code was provided in the eleventh step, the twelfth verification step also comprises that the received IMSI code and/or MSISDN code is compared, by the central server 150, to a predetermined corresponding respective IMSI code and/or MSISDN code which has been previously stored on the central server 150, such as in the database 151, and associated with the user account of the user 110. In this case, the thirteenth step in only performed if the received IMSI code and/or MSISDN code, respectively, matches the said previously stored corresponding code(s).

Using such a method, it is possible for the user 110 to quickly be able to provide the required identification information to the central server 150 without having to physically meet or interact with any staffed customer care center or the like. Also, the provision of the identification information can be performed as an integrated part of the registration process, either at the time of purchasing the SIM card or in connection to the first use of the communication services delivered using the SIM card. Also, distributed SIM cards do not have to be handled with high security, since it is only possible to use them by first validly registering them to a user account in the central server 150 in one of the above described different ways.

Furthermore, it is preferred that the twelfth verification step comprises verifying the validity of the piece of identification 111 based upon the digital photograph received by the central server 150 in the tenth step, and that the thirteenth step is only performed if such verification is affirmative.

According to one preferred embodiment, this verification is manually performed by staff at the operator of the central server 150.

However, it is preferred that the verification is automatic. Such automatic verification can preferably comprise analyzing the digital photograph provided to the central server 150 in the eleventh step, using conventional image analysis information such as automatic OCR (Optical Character Recognition) techniques being applied, after identifying where in the digital image the piece of identification 111 is located and its orientation in relation to the camera 121 at the time of the capture of the image. Such analysis preferably identifies any or a particular predetermined set of alphanumerical information 112 printed on the piece of identification 111, such as the name and birth date of the user 110, in the analyzed image. Then, the identified alphanumerical information 112 is interpreted, also using technology which is conventional as such, and compared to information already received and associated with the user 110 in the database 151, as described above. This way, the mobile device 120 is only granted access to the said mobile communication service if the alphanumerical information 112 printed on the piece of identification 111 actually corresponds to the information which is held by the central server 150, for instance as a part of a previously registered user account for the user 110.

According to another preferred embodiment, providing even higher security standards, the piece of identification 111 further comprises a photograph 113 of the user 110, preferably in the form of an image of the user's 110 face 110a. The photograph 113 may then analyzed, in addition to or instead of said alphanumerical information 112, by the central server 150 in the said twelfth verification step. Such analysis can comprise digitally analyzing the image 113 shown on the piece of identification 110 and the actual face 110a of the user 110 as it appears on the image provided to the central server 150 in the eleventh step, comparing the faces to each other based upon certain predetermined image parameters, and determining that the piece of identification 110 is invalid if the faces are more unlike than a predetermined value. Such parameterized image comparison techniques, in particular for facial recognition, are well-known in the art, and the skilled person knows how to select a suitable software-implemented algorithm for the present purposes.

In case an image of the actual face 110a of the user 110 is to be compared to an image, taken by the camera 121, depicting the photograph 113, either the user 110 can hold the piece of identification 110 so that is visible to the camera 121, together with the user's 110 face, in one and the same image. This is, for security reasons, also preferred even if the faces 110a, 113 are not to be automatically compared in the central server 150. Then, conventional image recognition software algorithms in the central server 150 are arranged to automatically identify the location and orientation in the image of the user 110 and the piece of identification 111, and further the location of the image 113 on the piece of identification 111, before the actual facial comparison is performed as described above.

As an alternative, in the eighth step, the user 110 is allowed to capture at least two images, one depicting the user 110 him- or herself, and in particular his or her face 110a; and one depicting the piece of identification 111. Then, such an additional photograph is communicated to the central server 150, in the eleventh step, preferably via the said interactive user interface.

In case the user 110 had the piece of identification 111 photographed previously, such as in connection to the purchase of the SIM card, the information 112 and/or 113 printed on the piece of identification 111 can be compared directly to the photographed image of the piece of identification 111 previously stored in the database 151.

In the system 100 aspect of the present invention, it is preferred that the system 100 is arranged to verify the authenticity of the image of the piece of identification 111 received from the mobile device 120 by performing an automatic image analysis of the received image as described above, extracting informational content and comparing the said content to corresponding information available to the central server 150 (such as via the same or an additional image of the user 110, or by comparing to user data already stored in the central server 150). Furthermore, the central server 150 is preferably arranged to not to cause the mobile communication device 120 to be provided access to the mobile communication service if the said verification is not positive.

Above, preferred embodiments have been described. However, it is apparent to the skilled person that many modifications may be made to the described embodiments without departing from the basic thought of the invention.

For instance, other biometric identification methods than an image of the user's 110 face 110a can be used, if supported by information available to the central server 150, such as via the identification 111.

Thus, the invention shall not be limited to the described embodiments, but may be varied within the scope of the enclosed claims.

1-13. (canceled)

14. Method for, by a central server (150), authenticating a user (110) of a mobile communication device (120) for the provision of mobile communication services for the mobile communication device (120), which mobile communication device (120) comprises a digital camera (121), which central server (150) keeps a user account relating to the user (110) and/or a SIM (Subscriber Identity Module) card which has been provided to the user (110) and inserted into the mobile communication device (120), wherein a piece of computer software, which is executable and executed on or from the mobile communication device (120), has been provided, the central server (150) has been provided with a digital communication interface, and the method comprises the steps of:
a) providing by the mobile communication device (120) an interface via which the user (110) can register or purchase a mobile communication service provided using the SIM card;
b) the piece of computer software reading information identifying the SIM card from the SIM card and communicating said information, via said digital communication interface, to the central server (150);
c) the central server (150) determining, based upon the information and further based upon which country or mobile communications network from which the mobile communication device (120) connects to the central server (150), whether or not the user is obliged to provide a valid piece of identification;
d) in case such piece of identification is required, the piece of software allowing the user (110) to take a digital photograph showing a piece of identification (111) using said digital camera (121) and communicating the photograph from the mobile communication device (120) to the central server (150), and causing the central server (150) to verify the photograph based upon user data associated with said user account; and
e) either if no identification is required or upon successful verification of the piece of identification, the central server (150) causing the mobile communication device (120) to be provided access to the mobile communication service.

15. Method according to claim 14, further comprising the piece of software allowing the user (110) to enter user data via an interface on the mobile communication device (120) and to communicate the user data to the central server (150), and the SIM card is not associated with the user (110) in the central server (150) before the entering of said user data.

16. Method according to claim 15, wherein the communication of the user data takes place after step c).

17. Method according to claim 14, wherein the verification comprises a manual verification step.

18. Method according to claim 14, wherein the verification is automatically performed and comprises analyzing the digital photograph, identifying alphanumerical information (112), such as the name and birth date of the user (110), in the analyzed image, and comparing the identified alphanumerical information (112) to user data already received and associated with the user (110) before step d.

19. Method according to claim 14, wherein, in addition to the piece of identification (111), the photograph, or alternatively an additional photograph also allowed to be taken by the user (110) using the mobile communication device (120) in step d) and also communicated to the central server (150) via said interface, shows the face (110a) of the user (110).

20. Method according to claim 19, wherein step e) is only performed upon the successful verification of the validity of the piece of identification (111), which verification comprises digitally analyzing an image (113) of a face printed on the piece of identification (111) and an image of the face (110a) of the user (110), comparing the faces to each other based upon certain predetermined image parameters, and determining that the piece of identification (111) is invalid if the faces are more unlike than a predetermined value.

21. Method according to claim 14, wherein said SIM card identifying information comprises an IMSI (International Mobile Subscriber Identity) code or MSISDN code of the SIM card, step d) further comprises communicating, from the mobile communication device (120) to the central server (150), the read IMSI and/or MSISDN code, the central server (150) compares the received IMSI and/or MSISDN code to a predetermined corresponding code which has been previously stored on the central server (150) for the user (110), and step e) is only performed if the received IMSI and/or MSISDN code matches the previously stored corresponding code.

22. Method according to claim 14, further comprising providing the digital communication interface by the central server (150) specifically for accepting SIM card identifying information from mobile communication devices (120).

23. Method according to claim 14, wherein an additional step performed before step a), the mobile communication device (120) is provided access to a specific internet address but not general internet access, the mobile communication device (120) can contact the central server (150) via said specific internet address, and in step e), the mobile communication device (120) is provided general internet access.

24. System for authenticating a user (110) of a mobile communication device (120) for the provision of mobile communication services for the mobile communication device (120), which mobile communication device (120) comprises a digital camera (121), which system comprises a central server (150) arranged to keep a user account relating to the user (110) and/or a SIM (Subscriber Identity Module) card, wherein the central server (150) is further arranged with a digital interface arranged to receive, from a piece of computer software which is executable and executed on or from the mobile communication device (120), information identifying a SIM card installed in the mobile communication device (120) and to determine, based upon the information and further based upon which country or mobile communications network from which the mobile communication device (120) connects to the central server (150), whether or not the user is obliged to provide a valid piece of identification, the central server (150) is furthermore arranged to, in case such identification is required, receive an image depicting a piece of identification (111) of the user (110) and to verify the received piece of identification based upon user data associated with said user account, and the central server (150) is arranged to, either if no identification is required or upon successful verification of the piece of identification, cause the mobile communication device (120) to be provided access to the mobile communication service.

25. System according to claim 24, wherein the verification comprises the authenticity of the received image by performing an automatic image analysis of the received image, extracting informational content and comparing the content to corresponding information available to the central server (150).

26. System according to claim 24, wherein the central server (150) is further arranged to receive user data from the piece of computer software, and the SIM card is not associated with the user (110) in the central server (150) before the receiving of said user data.

27. System according to claim 26, wherein the system is arranged to perform said determining before said user data has been communicated.

28. Computer software code runnable on or from a mobile communication device (120) comprising a digital camera (121), which software code is arranged to be used for authenticating a user (110) of the mobile communication device (120) for the provision of mobile communication services for the mobile communication device (120), which software code is arranged to provide, via the mobile communication device (120), an interface via which the user (110) can register or purchase a mobile communication service provided using a SIM card installed in the mobile communication device (120), wherein the software code is arranged to, as a part of a registration step of the SIM card, connect the mobile communication device (120) to a central server (150) keeping a user account relating to the user (110) and/or SIM card, to read information identifying a SIM card installed in the mobile communication device (120) and to provide this information to the central server (150) for a determination by the central server (150), based upon the information, whether or not the user is obliged to provide a valid piece of identification, the interface is arranged to subsequently, in case such identification is required, allow the user (110) to take a digital photograph showing a piece of identification (111) using said digital camera (121), and to communicate the photograph from the mobile communication device (120) to the central server (150) for verification of the received piece of identification based upon user data held by the central server (150).

29. Computer software code according to claim 28, wherein the software code is further arranged to allow the user (110) to enter said user data via an interface on the mobile communication device (120) and to communicate the user data to the central server (150).

30. Computer software code according to claim 29, wherein the communication of the user data takes place after the communication of the SIM card identifying information.
